(19) United States
(12) Patent Application Publication
(10) Pub. No.: US 2025/0279858 A1
(43) Pub. Date: Sep. 4, 2025

(54) DATA TRANSMISSION ACKNOWLEDGEMENT, APPARATUS, AND STORAGE MEDIUM

(71) Applicant: ZTE CORPORATION, Shenzhen, Guangdong (CN)

(72) Inventors: Wei GOU, Shenzhen, Guangdong (CN); Xing LIU, Shenzhen, Guangdong (CN); Shuaihua KOU, Shenzhen, Guangdong (CN); Xingguang WEI, Shenzhen, Guangdong (CN); Jing SHI, Shenzhen, Guangdong (CN)

(21) Appl. No.: 18/859,150

(22) PCT Filed: Jul. 5, 2022
(86) PCT No.: PCT/CN2022/103935

§ 371 Date: Oct. 22, 2024

(51) Int. Cl. H04L 1/1829; H04W 72/21

(52) U.S. Cl. CPC H04L 1/1864; H04W 72/21

(57) ABSTRACT

A wireless communication method includes receiving, from a base station, the one or more signalings, where the one or more signalings are used to configure a user equipment (UE) to transmit a HARQ-ACK feedback according to a preset rule and/or to configure a size of the HARQ-ACK feedback in a case that the size of the HARQ-ACK feedback is equal to or less than 4 bits and/or when the UE is configured with one or more G-RNTIs (Group Radio Network Temporary Identities); and transmitting the HARQ-ACK feedback via a PUCCH resource selected according to the preset rule.

### CROSS REFERENCE OF RELATED APPLICATION

This disclosure is based upon and claims priority to the International Application No. PCT/CN2022/103935, filed on Jul. 5, 2022, the entire contents of which are incorporated herein by reference.

### TECHNICAL FIELD

This disclosure is generally related data transmission acknowledgment, and more particularly to the management of data transmission acknowledgment.

### BACKGROUND

Wireless communication technologies are pivotal components of the increasingly interconnecting global communication networks. Wireless communications rely on accurately allocated time and frequency resources for transmitting and receiving wireless signals. When a user equipment (UE) properly receives a transmission block (TB) from a base station (BS), a UE can select different modes to report that the TB transmitted by the BS is properly received or to report that the TB is missed or otherwise problematic. However, misunderstanding between the schedule data and the meaning of the reported information cause a technical issue on properly identifying and retransmitting the missing TB.

### SUMMARY

This summary is a brief description of certain aspects of this disclosure. It is not intended to limit the scope of this disclosure.

An embodiment of this disclosure provides a wireless communication method, including receiving, from a base station, the one or more signalings, wherein the one or more signalings are used to configure a user equipment (UE) to transmit a HARQ-ACK feedback according to a preset rule and/or to configure a size of the HARQ-ACK feedback in a case that the size of the HARQ-ACK feedback is equal to or less than 4 bits and/or when the UE is configured with one or more G-RNTIs (Group Radio Network Temporary Identities); and transmitting the HARQ-ACK feedback via a PUCCH resource selected according to the preset rule.

Another embodiment of this disclosure provides a wireless communication method, including: transmitting, from a base station, one or more signalings, wherein the one or more signalings are used to configure a user equipment (UE) to transmit a HARQ-ACK feedback according to a preset rule and/or to configure a size of the HARQ-ACK feedback when the size of the HARQ-ACK feedback is equal to or less than 4 bits and/or when the UE is configured with one or more G-RNTIs (Group Radio Network Temporary Identities); and receiving the HARQ-ACK feedback via a PUCCH resource selected according to the preset rule.

Still another embodiment of this disclosure provides a wireless communication method, including: receiving, from a base station (BS), a signaling, wherein the signaling is used to configure a user equipment (UE) to transmit a HARQ-ACK feedback according to a preset rule in a case that a size of the HARQ-ACK feedback is equal to or less than 4 bits and/or when the UE is configured with one or more G-RNTIs (Group Radio Network Temporary Identities); generating the HARQ-ACK feedback by adding at least one NACK bit at the end of the HARQ-ACK feedback in response to an original size of the HARQ-ACK feedback is determined less than four bits based on a Counter-Downlink Assignment Index (C-DAI) in downlink control information; and transmitting the HARQ-ACK feedback to the base station (BS).

Still another embodiment of this disclosure provides a wireless communication method, including: transmitting, from a base station (BS), a signaling, wherein the signaling is used to configure a user equipment (UE) to transmit a HARQ-ACK feedback according to a preset rule in a case that a size of the HARQ-ACK feedback is equal to or less than 4 bits and/or when the UE is configured with one or more G-RNTIs (Group Radio Network Temporary Identity); receiving the HARQ-ACK feedback, wherein one or more last few bits of the HARQ-ACK feedback are of a NACK value; determining whether the one or more last few bits of the of the HARQ-ACK feedback correspond to a previously scheduled transmission blocks (TBs); and retransmitting a previously scheduled TB corresponding to the one or more last few bits of the of the HARQ-ACK feedback of the NACK value.

Still another embodiment of this disclosure provides a wireless communication method, including: receiving, from a base station, a signaling, wherein the signaling is used to configure a user equipment (UE) either: to transmit a HARQ-ACK feedback according to a preset rule in a case that a size the HARQ-ACK feedback is equal to or less than 4 bits and/or in a case that the UE is configured with one or more G-RNTIs (Group Radio Network Temporary Identities); or to transmit the HARQ-ACK feedback via a PUCCH resource designated by a signaling; listening one or more pieces of downlink control information (DCI), wherein a PUCCH resource indication (PRI) field in the one or more pieces of DCI indicate a sequence or a number of one or more transmission blocks (TBs) and/or indicate the last transmission block (TB) or DCI; and transmitting the HARQ-ACK feedback via a selected PUCCH resource according to the preset rule in a case that the size of the HARQ-ACK feedback is equal to or less than 4 bit and/or in a case that the UE is configured with one or more G-RNTIs.

Still another embodiment of this disclosure provides a wireless communication method, including: transmitting, from a base station, a signaling, wherein the signaling is used to configure a user equipment (UE) either: to transmit a HARQ-ACK feedback according to a preset rule in a case that a size the HARQ-ACK feedback is equal to or less than 4 bits and/or in a case that the UE is configured with one or more G-RNTIs (Group Radio Network Temporary Identities); or to transmit the HARQ-ACK feedback via a PUCCH resource designated by a signaling; transmitting one or more pieces of downlink control information (DCI), wherein a PUCCH resource indication (PRI) field in the one or more pieces of DCI indicate a sequence or a number of one or more transmission blocks (TBs) and/or indicate the last transmission block (TB) or DCI; and receiving the HARQ-ACK feedback via a selected PUCCH resource according to the preset rule in a case that the size of the HARQ-ACK feedback is equal to or less than 4 bit and/or in a case that the UE is configured with one or more G-RNTIs.

Still another embodiment of this disclosure provides a wireless communication apparatus, including a memory storing one or more programs and a processor electrically coupled to the memory and configured to execute the one or more programs to perform any method or step or their combination in this disclosure.

Still another embodiment of this disclosure provides non-transitory computer-readable storage medium, storing one or more programs, the one or more program being configured to, when executed by a processor, cause to perform any method or step or their combination in this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary wireless communication system, which can implement the methods and/or steps in this disclosure;

FIG. 2 illustrates data transmission between a user equipment and a base station;

FIG. 3 illustrates transmission of transmission blocks among different G-RNTI;

FIG. 4 illustrates steps of a wireless communication method of this disclosure;

FIG. 5 illustrates steps of another wireless communication method of this disclosure;

FIG. 6 illustrates steps of another wireless communication method of this disclosure; and

FIG. 7 illustrates steps of another wireless communication method of this disclosure.

### DETAILED DESCRIPTION

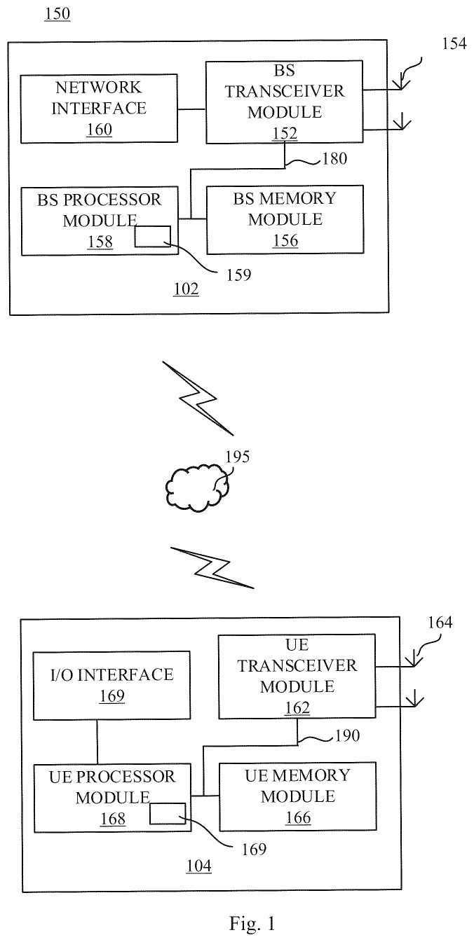

FIG. 1 illustrates a block diagram of an exemplary wireless communication system 150, in accordance with some embodiments of this disclosure. The system 150 may perform the various methods/steps disclose below. The system 150 may include components and elements configured to support operating features that need not be described in detail herein.

The system 150 may include a base station (BS) 102 and a user equipment (UE) 104. The BS 102 includes a BS transceiver or transceiver module 152, a BS antenna system 154, a BS memory or memory module 156, a BS processor or processor module 158, and a network interface 160. The components of BS 102 may be electrically coupled and in communication with one another as necessary via a data communication bus 180. Likewise, the UE 104 includes a UE transceiver or transceiver module 162, a UE antenna system 164, a UE memory or memory module 166, a UE processor or processor module 168, and an I/O interface 169. The components of the UE 104 may be electrically coupled and in communication with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from a transmitting antenna of the UE 104 (referred to singular form for convenience, but can include multiple antennae) to a receiving antenna of the BS 102 (referred to singular form for convenience, but can include multiple antennae) is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a RF transmitter and receiver circuitry that are each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. There may be close synchronization timing with only a minimal guard time between changes in duplex direction. The UE transceiver 162 communicates through the UE antenna 164 with the BS 102 via the wireless communication channel 192. The BS transceiver 152 communicates through the BS antenna 154 of a BS (e.g., the first BS 102) with the other BS (e.g., the second BS 102-2) via a wireless communication channel 192. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long-Term Evolution (LTE) and 5G standards (e.g., NR), and the like. It is understood, however, that the invention is not necessarily limited in application to a particular standard and associated protocols. Rather, the UE transceiver 162 and the BS transceiver 152 may be configured to support alternative, or additional, wireless data communication protocols, including future standards or variations thereof.

The processor modules 158 and 168 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)) or one or more core network 195 for mobile communications. The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

For a 5G system, a physical downlink control channel (PDCCH) can be used for dynamic scheduling in order to deliver downlink control information (DCI). The DCI includes the information used by the UE to process the scheduled data. For data scheduling of downlink transmission, the scheduling DCI may also include radio resource and/or timing information of the Hybrid ARQ-Acknowledgement (HARQ-ACK) feedback. After a UE receives the downlink data, the UE may report its HARQ-ACK by the physical uplink control channel (PUCCH). The PUCCH used to transmit the HARQ-ACK feedback can be determined by different methods.

For the first HARQ-ACK reporting mode, the UE may generate HARQ-ACK information with ACK value when a UE correctly decodes a TB or detects a DCI format indicating an SPS PDSCH release; otherwise, the UE generates HARQ-ACK information with NACK value.

For the second HARQ-ACK reporting mode, the UE does not transmit a PUCCH that would include only HARQ-ACK information with ACK values.

In a first HARQ-ACK reporting mode, the PUCCH used to transmit the HARQ-ACK feedback can be indicated by a signaling, such as a PUCCH resource indication (PRI) field in the DCI. The PRI field indicates which PUCCH resource the UE should use to transmit a HARQ-ACK feedback of a TB corresponding to the DCI indicating the PUCCH. In this first HARQ-ACK reporting mode, the UE may choose to transmit HARQ-ACK feedback whether or not a TB is properly received/decoded by the UE. That is, the UE may transmit a confirmation to the BS to report the successful receipt of the TB. The UE may also transmit a report to the BS to let the BS know that the corresponding TB is missing, such that the BS may retransmit the missing TB.

In a second HARQ-ACK reporting mode, the UE may transmit the HARQ-ACK feedback only when any one of TB is missing or not decoded correctly during before an assigned report time slot. Table 1 includes a mapping relationship between the decoding result of the received TBs and the PUCCH resource. Specifically, based on the decoding result of the received TBs, the UE can determine whether a TB is properly received. If a TB is properly received, the corresponding HARQ-ACK value would be of an ACK value, such as 1 (or otherwise as 0 depending on the design of the system). As explained above, if all the TBs are properly received, then there is no need to transmit a HARQ-ACK feedback in this reporting mode. Alternatively, if anyone of the TBs, except for the last TB of the TBs whose HARQ-ACKs are to be reported in a HARQ-ACK feedback under the second report mode, from one TB to at most four TBs as an example, is not properly received before a reporting time slot, the UE may generate a HARQ-ACK feedback with a NACK value at the corresponding bit(s). For example, if the UE understands that, based on the C-DAI information in the DCI, there are four scheduled TBs which are transmitted by the BS and whose HARQ-ACKs are designated to be reported by the UE in a same time slot and only the first and fourth TBs among four are well received, the HARQ-ACK value can be {1, 0, 0, 1}, where “1” indicates successful transmission and “0” indicates NACK. According to Table 1, which depicts a relationship between the value of the HARQ-ACK feedback and the PUCCH resource used to transmit the HARQ-ACK feedback, the UE will use the tenth PUCCH resource provided by pucch-ResourceId obtained from the tenth value of resourceList to transmit the HARQ-ACK feedback to the BS.

TABLE 1

| HARQ-ACK Value | | | | PUCCH resource |
|---|---|---|---|---|
| {0} | {0, 0} | {0, 0, 0} | {0, 0, | 1^{st} PUCCH resource provided by |
| | | | 0, 0} | pucch-ResourceId obtained from the |
| | | | | 1^{st} value of resourceList |
| | {1, 0} | {1, 0, 0} | {1, 0, | 2^{nd} PUCCH resource provided by |
| | | | 0, 0} | pucch-ResourceId obtained from the |
| | | | | 2^{nd} value of resourceList |
| | {0, 1} | {0, 1, 0} | {0, 1, | 3^{rd} PUCCH resource provided by |
| | | | 0, 0} | pucch-ResourceId obtained from the |
| | | | | 3^{rd} value of resourceList |
| | | {1, 1, 0} | {1, 1, | 4^{th} PUCCH resource provided by |
| | | | 0, 0} | pucch-ResourceId obtained from the |
| | | | | 4^{th} value of resourceList |
| | | {0, 0, 1} | {0, 0, | 5^{th} PUCCH resource provided by |
| | | | 1, 0} | pucch-ResourceId obtained from the |
| | | | | 5^{th} value of resourceList |
| | | {1, 0, 1} | {1, 0, | 6^{th} PUCCH resource provided by |
| | | | 1, 0} | pucch-ResourceId obtained from the |
| | | | | 6^{th} value of resourceList |
| | | {0, 1, 1} | {0, 1, | 7^{th} PUCCH resource provided by |
| | | | 1, 0} | pucch-ResourceId obtained from the |
| | | | | 7^{th} value of resourceList |
| | | | {1, 1, | 8^{th} PUCCH resource provided by |
| | | | 1, 0} | pucch-ResourceId obtained from the |
| | | | | 8^{th} value of resourceList |
| | | | {0, 0, | 9^{th} PUCCH resource provided by |
| | | | 0, 1} | pucch-ResourceId obtained from the |
| | | | | 9^{th} value of resourceList |
| | | | {1, 0, | 10^{th} PUCCH resource provided by |
| | | | 0, 1} | pucch-ResourceId obtained from the |
| | | | | 10^{th} value of resourceList |
| | | | {0, 1, | 11^{th} PUCCH resource provided by |
| | | | 0, 1} | pucch-ResourceId obtained from the |
| | | | | 11^{th} value of resourceList |
| | | | {1, 1, | 12^{th} PUCCH resource provided by |
| | | | 0, 1} | pucch-ResourceId obtained from the |
| | | | | 12^{th} value of resourceList |
| | | | {0, 0, | 13^{th} PUCCH resource provided by |
| | | | 1, 1} | pucch-ResourceId obtained from the |
| | | | | 13^{th} value of resourceList |
| | | | {1, 0, | 14^{th} PUCCH resource provided by |
| | | | 1, 1} | pucch-ResourceId obtained from the |
| | | | | 14^{th} value of resourceList |
| | | | {0, 1, | 15^{th} PUCCH resource provided by |
| | | | 1, 1} | pucch-ResourceId obtained from the |
| | | | | 15^{th} value of resourceList |

In the second mode, the PRI field in the DCI is not used to designate the PUCCH to be used by the UE to transmit the HARQ-ACK feedback because the resource of the HARQ-ACK feedback is determined by the Table 1, a preset rule agreed between the BS and the UE. It would be beneficial to reuse or reinterpret the PRI field.

Additionally, in the second mode mentioned above, the BS and the UE may cause misunderstanding on the HARQ-ACK feedback if the last DCI used to schedule the transmission of the downlink data is not properly received. For example, the BS may send three downlink DCIs to schedule 3 TBs (which may correspond to a single G-RTNI (Group Radio Network Temporary Identity) or multiple G-RNTIs). It is possible that the UE only receives the TBs scheduled by the first two downlink DCIs. The third downlink DCI was missed, so the third TB was not received. In this case, under the second mode, the BS expects the UE to generate an HARQ-ACK feedback based on the decoding result of 3 TBs (to determine whether the TBs are properly received), to determine the PUCCH resource based on Table 1, and to transmit the determined PUCCH. On the other hand, the UE generates the HARQ-ACK feedback only based on the two received TBs (and the two received DCIs), determines the PUCCH resource based on Table 1, and transmits the determined PUCCH.

When the last DCI is not received by the UE in a report cycle and the UE decodes the first two TBs correctly, the UE will not transmit the PUCCH with the HARQ-ACK feedback based on Table 1 because the UE presumes that all the scheduled TBs are properly received. However, in this situation, the BS erroneously determines that all three TBs are correctly received (because under the second mode, a UE would not transmit a HARQ-ACK feedback if all scheduled TBs are properly received), then the BS will not retransmit the third TB; the UE for this reason will not receive the third TB.

According to one embodiment, this disclosure provides a wireless communication method, including:
S110: receiving, from a base station, a signaling, wherein the signaling is used to configure a user equipment (UE) either:
to transmit a HARQ-ACK feedback according to a preset rule in a case that a size the HARQ-ACK feedback is equal to or less than 4 bits and/or in a case that the UE is configured with one or more G-RNTIs (Group Radio Network Temporary Identities); or
to transmit the HARQ-ACK feedback via a PUCCH resource designated by a signaling;
S120: listening one or more pieces of downlink control information (DCI), wherein a PUCCH resource indication (PRI) field in the one or more pieces of DCI indicate a sequence or a number of one or more transmission blocks (TBs) and/or indicate the last transmission block (TB) or DCI; and
S130: transmitting the HARQ-ACK feedback via a selected PUCCH resource according to the preset rule in a case that the size of the HARQ-ACK feedback is equal to or less than 4 bit and/or in a case that the UE is configured with one or more G-RNTIs.

Correspondingly, this disclosure provides a wireless communication method, which can be performed by a BS, including:
transmitting, from a base station, a signaling, wherein the signaling is used to configure a user equipment (UE) either:
to transmit a HARQ-ACK feedback according to a preset rule in a case that a size of the HARQ-ACK feedback is equal to or less than 4 bits and/or in a case that the UE is configured with one or more G-RNTIs (Group Radio Network Temporary Identities); or
to transmit the HARQ-ACK feedback via a PUCCH resource designated by a signaling;
transmitting one or more pieces of downlink control information (DCI), wherein a PUCCH resource indication (PRI) field in the one or more pieces of DCI indicate a sequence or a number of one or more transmission blocks (TBs) and/or indicate the last transmission block (TB) or DCI; and
receiving the HARQ-ACK feedback via a selected PUCCH resource according to the preset rule in a case that the size of the HARQ-ACK feedback is equal to or less than 4 bit and/or in a case that the UE is configured with one or more G-RNTIs.

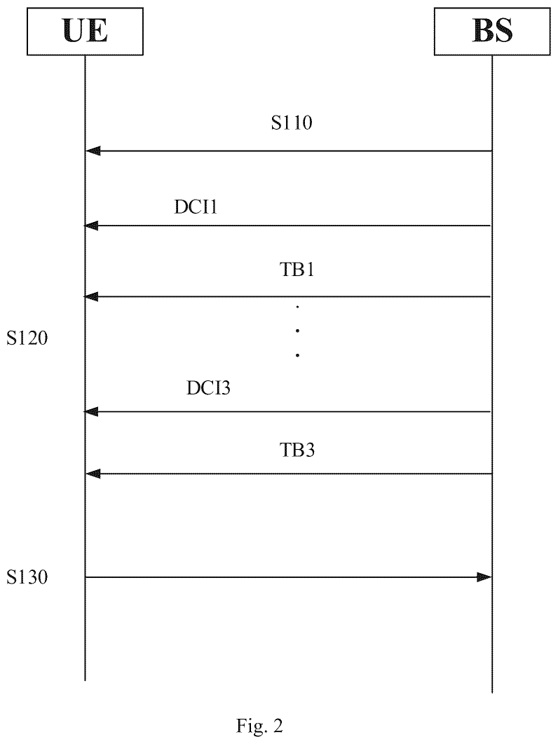

FIG. 2 illustrates the operation between the UE and the BS according to the method above. In S110, the BS may send a signaling. This signaling may be used to configure the UE's manner in transmitting the HARQ-ACK feedback. For example, the BS can configure the UE, with an RRC signaling, to either transmit a HARQ-ACK feedback according to a preset rule in a case that a size the HARQ-ACK feedback is equal to or less than 4 bits and/or in a case that the UE is configured with one or more G-RNTIs (Group Radio Network Temporary Identities)—which may corresponds to the second reporting mode explained above; or transmit the HARQ-ACK feedback via a PUCCH resource designated by a signaling—which may corresponds to the first reporting mode explain above.

The UE may use the second mode to report the HARQ-ACK feedback when the size of the HARQ-ACK feedback is less than or equal to four bits. As shown in Table 1 above, the second reporting mode allocates 15 PUCCH channels for the HARQ-ACK feedback reporting purpose, so the HARQ-ACK feedback can either has one, two, three, or four bits. Additionally, the UE may use the second mode to report the PUCCH when the UE is configured with one or more G-RNTIs (Group Radio Network Temporary Identities).

In S120, to implement the downlink transmission, the UE listens to the DCI transmitted from the BS. The DCI can schedule the downlink transmission and schedule the time domain information for reporting the HARQ-ACK feedback. In this case, each DCI can be used to schedule the downlink transmission of one TB. There can be multiple TBs scheduled before a report of the HARQ-ACK feedback.

When the UE uses the first mode to report the HARQ-ACK feedback, a filed in the DCI can be used to indicate the PUCCH used to report the HARQ-ACK feedback. This field can be a PRI field. In the second mode, the PRI field can be reinterpreted because the PRI field does not need to indicate the PUCCH for transmitting the HARQ-ACK feedback as the UE may determine the PUCCH resource for transmitting the HARQ-ACK feedback based on a preset rule, such as the rule illustrated in Table 1, which depicts the relationship between the value of the HARQ-ACK feedback and the PUCCH used to transmitted the HARQ-ACK feedback.

In one implementation, the BS's assignment to the PRI field in the downlink DCI is based on the (time domain) order of the TBs scheduled by the BS across different G-RNTIs. For example, the BS may assign values to the PRI fields in the corresponding downlink DCI according to the order of the scheduled TBs, regardless of the order of the G-RNTIs corresponding to the TBs. If the UE is instructed to determine the PUCCH resources from Table 1 for this second HARQ-ACK report, the UE may determine the number and order of HARQ-ACK information of the scheduled TBs based on the value of the PRI field in the DCI corresponding to the scheduled TB.

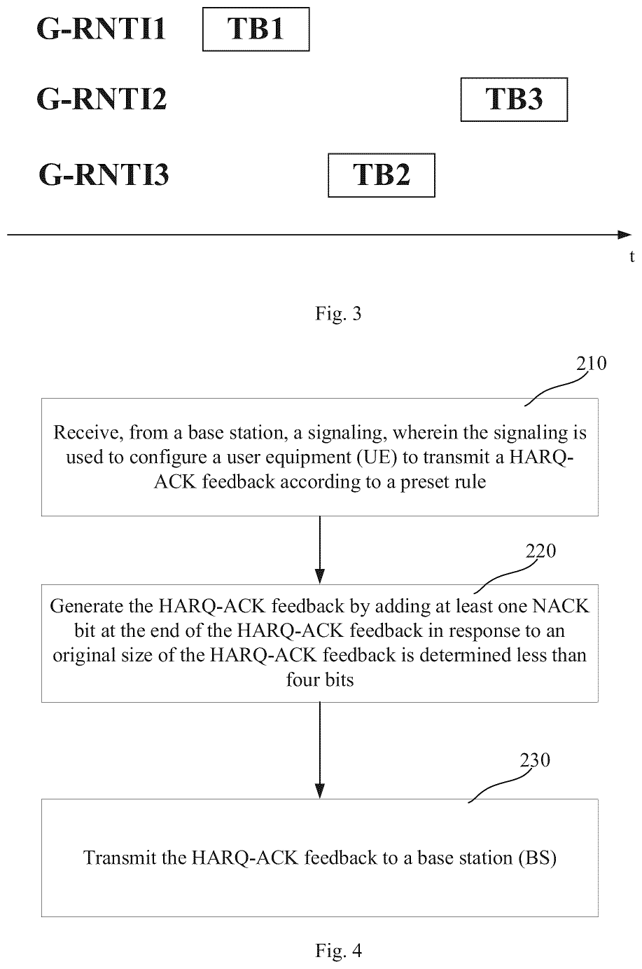

For example, in FIG. 3, there are three scheduled TBs in an MBS group corresponding to different G-RNTIs, G-RNTI1 to G-RNTI3. The order (in time domain) of the TBs is the TB of G-RNTI1, the TB of G-RNTI3, and the TB of G-RNTI2. Here, the BS may assign values to the PRI fields in the DCIs corresponding to the three TBs respectively based on the order of the three TBs in time domain. Specifically, the PRI in the DCI corresponding to the TB1 of G-RNTI1 is given a value of 1, the PRI in the DCI corresponding to the TB2 of G-RNTI3 is given a value of 2, and the PRI in the DCI corresponding to the TB3 of G-RNTI2 is given a value of 3.

After the UE receives the DCIs sent by the BS, the UE may determine the number and order/sequence of HARQ-ACK information corresponding to the three (as an example) scheduled TBs based on the values of the PRI fields when the UE reports the HARQ-ACK feedback to the BS, and determines a PUCCH resource based on the decoding results of the three TBs from Table 1 and transmits the PUCCH. For example, if TB1 and TB2 are properly received/decoded, but TB3 is not properly received/decoded, the UE may, in S130, determine a value of the HARQ-ACK feedback as {1, 1, 0}. According to Table 1, the UE may use the fourth PUCCH resource provided by pucch-ResourceId obtained from the fourth value of resourceList. Here, the PRI field can be used as an indication to the order/sequence and or number of the DCI corresponding to the respective TB, so a UE can use the PRI's value to determining the relationship between the bits of the HARQ-ACK feedback and the TBs.

It should be noted that if the UE determines that the size of the HARQ-ACK feedback is more than four bits, the UE interprets the PRI field in the DCI according to its original manner under the first reporting mode, which is used to indicate the specific PUCCH resource the UE should use to transmit the HARQ-ACK feedback.

In other words, the meaning of the PRI field in the downlink DCI can be determined based on the number of bits of the HARQ-ACK feedback. Specifically, the PRI field in the DCI is understood as the count and order of the DCI (or scheduled TB) when the UE is instructed to perform the HARQ-ACK reporting under the second mode, which determines the PUCCH from Table 1. In one implementation, the PRI field can be generally of three bits. Here, some bits in the three bits can be reinterpreted. For example, the lower two bits can reinterpret to indicate the count and order of the DCI.

On the BS sides, if a size the HARQ-ACK feedback is equal to or less than 4 bits and/or in a case that the UE is configured with one or more G-RNTIs, the BS expects the UE to use the Table 1 to determine the PUCCH resource for reporting the HARQ-ACK feedback. On the other hand, for a second HARQ-ACK report, if the BS determines that a size of the HARQ-ACK feedback exceeds 4 bits, then the BS expects the UE to report the HARQ-ACK feedback according to the first reporting mode. In this case, the PRI field may be no longer reinterpreted to instruct the sequence and/or number of the DCI. But, the PRI field is used to indicate a PUCCH resource the UE should use to report the HARQ-ACK feedback.

According to one implementation, this method further includes determining a bit of the HARQ-ACK feedback is NACK when corresponding downlink control information (DCI) or TB is not received. Specifically, when a UE fails to properly receive DCI or a TB (including fails to correctly decode a received TB), the UE may determine a bit of the HARQ-ACK feedback corresponding to the TB as NACK. For example, a NACK value can be represented as a value “0.” The UE may determine which bit should be NACK for the failure according to the sequence of the TB. For example, if the TB the UE failed to receive is the first scheduled TB in a HARQ-ACK feedback, the UE determines the first bit of the HARQ-ACK feedback (which corresponds to the missing TB) is NACK.

According to one implementation, this method further includes receiving one or more pieces of corresponding DCI indicating a sequence or a number of one or more transmission blocks (TBs). To inform of the UE of the sequence or order of the TBs scheduled by the BS, the BS may further transmit and the UE may receive one or more pieces of corresponding DCI. The DCIs can be used to indicate the sequence or a total number of the TBs scheduled by the TB.

According to one implementation, the one or more pieces of corresponding DCI includes a Counter-Downlink Assignment Index (C-DAI) for indicating a sequence or a number of the TBs; or a PUCCH resource indication (PRI) for indicating a sequence or a number of the TBs. In one implementation, the field used by the DCI to indicate the sequence or the number of the TBs can be a Counter-Downlink Assignment Index or a PUCCH resource indication field.

According to one implementation, the size of the HARQ-ACK feedback is N bit(s), N being a positive integer less than 5; and Kth to Nth bit(s) of the HARQ-ACK feedback are determined to have a NACK value, wherein the (K−1)th TB is the last TB received by the UE, K being a positive integer less than or equal to N. For example, the size of the HARQ-ACK feedback can be 3 bits. This size as mentioned above, can be determined by the BS using a signaling or can be preset as a default rule when there is no received signaling to configure the size of the HARQ-ACK feedback. When the first TB is the last TB received by the UE, the UE may determine that bits 2 to 3 (that is K is 2) is NACK.

In one example, the UE can supplement that last few bit(s) as NACK even if the UE does not receive the DCI that schedules the last few TB(s). For example, in a case that the UE does not receive DCI that schedules the last few TB(s), theoretically the UE may not know that there are some TB(s) is scheduled by the BS and are supposed to be received by the UE. In a conventional design, if the UE does not know that there are additional TB(s) supposed to be receive. Because the UE receives the TB the UE determined supposed to receive according to the received, the UE will not report a HARQ-ACK feedback under the second reporting mode. However, in this implementation here, the UE may still supplement a NACK value if the number of TBs it received corresponds to a smaller size of the HARQ-ACK feedback. The UE may supplement one or more NACK bits to the HARQ-ACK feedback until it reaches the predetermined size, and report the HARQ-ACK feedback with one or more NACK bits.

According to one implementation, one or more 1st to (K−1)th bits of the HARQ-ACK feedback are determined to have a NACK value in a case that the UE receives the Kth TBs but fails to receive one or more TBs corresponding to the one or more 1st to (K−1)th bits of the HARQ-ACK feedback determined to have the NACK value. Additionally, if the UE receives a TB, which according to the DCI is a TB scheduled following one or more preceding TBs, but the UE does not receive the one or more preceding TBs, the UE may determine that the one or more bits corresponding to the one or more non-received preceding TBs as NACK. For example, if the UE receives a TB, indicated by the DCI as the third TB, but the UE has not received the first and the second TBs, the UE may determine the bits of the HARQ-ACK feedback corresponding to the non-received first and second TBs as NACK. In this case, if the configured size of the HARQ-ACK feedback is 3 bits, the UE may report a HARQ-ACK feedback as {0, 0, 1}. According to Table 1, the UE may use the fifth PUCCH resource for the reporting.

According to one implementation, the method further comprises in a case that the size of the HARQ-ACK feedback is determined, based on the one or more pieces of DCI, smaller than the configured size of the HARQ-ACK feedback, adding one or more NACK bits at the end of the HARQ-ACK feedback to prepare the HARQ-ACK feedback having the configured size. For example, the UE may determine a size of the HARQ-ACK feedback based on the DCI. If the UE determined that according to the DCI the size of the HARQ-ACK feedback is less than a configured or predetermined size of the HARQ-ACK feedback, the UE may supplement the NACK bit at the end of the HARQ-ACK feedback. For example, if the one or more pieces of DCI received by the UE indicated that the last TB should be the third TB, the UE based on the received DCI may determine the HARQ-ACK feedback is of three bits. However, if the configured or predetermined size of the HARQ-ACK feedback (for example, as configured by the BS via an RRC signaling or by a default setting) is four bits, larger than the size indicated by the DCI, the UE may supplement the NACK bit at the last few bits of the HARQ-ACK feedback (in this case the last bit) such that the actual HARQ-ACK feedback transmitted by the UE meets the required size of the HARQ-ACK feedback as configured or predetermined.

According to one implementation, the size of the HARQ-ACK feedback is larger than a number of TBs the BS scheduled to be transmitted or the configured size of the HARQ-ACK feedback is larger than the size of the HARQ-ACK feedback determined based on the one or more pieces of DCIs. Because the UE may supplement one or more bits to the HARQ-ACK feedback (with a NACK value as an example), the configured size of the HARQ-ACK feedback (that can be the size of the HARQ-ACK feedback actually transmitted as the UE needs to comply with the configuration) can be larger than the HARQ-ACK feedback the UE can tell from the DCI scheduling the transmission of the TBs.

According to one implementation, in a case that the one or more signalings do not configured the size of the HARQ-ACK feedback, the UE transmit the HARQ-ACK feedback with a preset size. For example, in a case that the UE does not receive or the BS does not transmit a signaling to configure the size of the HARQ-ACK feedback, the UE can alternatively use a default setting of the size of the HARQ-ACK feedback.

According to one implementation, the method further includes determining whether a bit of the HARQ-ACK feedback having a NACK value corresponds to a previously-scheduled TB.

According to one implementation, the method further includes, in a case that the bit of the HARQ-ACK feedback having a NACK value corresponds to a previously-scheduled TB, retransmitting the corresponding previously-scheduled TB.

According to one implementation, the method further comprises, in a case that the bit of the HARQ-ACK feedback having a NACK value, is devoid of a corresponding previously-scheduled TB, disregarding the bit of the HARQ-ACK feedback having a NACK value.

Specifically, because the UE may supplement one or more NACK bits in the HARQ-ACK feedback even if the UE does not receive a DCI confirming a certain TB is scheduled corresponding to the supplemented bit, the BS may need to determine whether a bit of the HARQ-ACK feedback having a NACK value actually corresponds to a previously-scheduled TB after the BS receives the HARQ-ACK feedback from the UE. For example, if the BS receives a HARQ-ACK feedback with {1, 1, 0, 0}, it is possible that the first NACK (the third bit from the left) corresponds to a previously scheduled TB (which was not received by the UE), while the last NACK bit (the fourth bit overall) does not correspond to any previously scheduled TB, or vice versa. The NACK does not correspond to a previously scheduled TB because the UE supplement such bit while it does not receive DCI schedule the corresponding TB.

Once the TB receives a HARQ-ACK feedback with a NACK value, it may check whether each NACK value corresponding to one previously scheduled TB. If not, the BS may disregard the NACK value without retransmitting the TBs. On the other hand, if the BS determines that the NACK indicates a missing TB (not properly received or decoded by the UE), the BS may retransmit the TB.

In one implementation, the DCI may include one parameter indicating an end DCI (or end TB) for the HARQ-ACK feedback to be reported in the second mode. This parameter indicating the last DCI or last TB in a reporting cycle can be a newly added parameter. This parameter can also be done by reinterpretation of an existing parameter field, such as the PRI field.

For the second HARQ-ACK feedback reporting mode when a UE is configured with one or more G-RNTIs (or the number of HARQ-ACK information bits does not exceed 4 bits), the UE can be indicated by RRC signaling from the BS to provide the HARQ-ACK feedback according to the HARQ-ACK feedback's value, following the relationship as shown in Table 1. For reporting HARQ-ACK feedback under the second mode, the BS may use the DCI to indicate the DCI corresponding to the fourth TB in the reporting cycle as the last DCI. The BS is prohibited from requesting the UE to include more than four bits in a HARQ-ACK feedback.

The UE may consider the PRI field in the DCI of the scheduled TB to indicate the last DCI for a HARQ-ACK report under the second reporting mode. If a UE is instructed to select a PUCCH from Table 1 for sending the HARQ-ACK feedback and if the PRI field indicates that the current DCI is a last DCI, the UE determines that the HARQ-ACK feedback's value corresponding to the TB and the last DCI is the last HARQ-ACK value for the HARQ-ACK report in the second mode. Therefore, the UE have the information on whether the last DCI or last TB is received based on the identity of the last DCI.

For a UE reporting the HARQ-ACK feedback in the second mode, if the last DCI is not one of the DCIs received by the UE, the UE may determine that the last DCI corresponding the HARQ-ACK feedback is missing. The UE can thereby supplement NACK values at the end of the HARQ-ACK feedback. Additionally, one or more NACK values may be supplemented until the HARQ-ACK feedback reaches the configured or predetermined size, such as 4 bits. Alternatively, at least one (or just one) NACK can be supplemented to the HARQ-ACK feedback. Once the BS receives the HARQ-ACK feedback with a NACK value, it can determine whether each NACK value eventually corresponds to a previously scheduled TB.

To report a HARQ-ACK feedback under the second mode, the UE expects that the PRI field in the DCI corresponding to the fourth TB may be set to be the last DCI. The UE may determine the HARQ-ACK feedback based on the last DCI and determine the PUCCH resource based on Table 1.

On the other hand, if the UE has received 4 TBs, but the UE still has not received the TB corresponding to the last DCI (meaning that there is supposed to have at least one additionally TB incoming), then the UE may generate and transmit the HARQ-ACK feedback according to the first HARQ-ACK reporting mode. In this case, the UE may no longer generate and report HARQ-ACK feedback according to the second HARQ-ACK reporting mode because the size of the HARQ-ACK feedback is supposed to be larger than four in view of received four TBs and the missing unknown TB.

Correspondingly, if the BS has sent more than four TBs and still does not indicate the TB corresponding to the last DCI, the BS expects the UE to generate and send the HARQ-ACK feedback according to the first HARQ-ACK reporting mode. The BS expects the UE to no longer generate and report the HARQ-ACK feedback according to the second HARQ-ACK reporting mode.

Additionally, if the UE receives more than 4 TBs (or generates more than 4 bits of HARQ-ACK information) under the second HARQ-ACK reporting mode, the UE generates and reports HARQ-ACK feedback according to the first HARQ-ACK reporting mode. Under the first mode, the UE does not use the setting in Table 1. Instead, the UE uses the PRI field that designates the resource to be used for HARQ-ACK feedback.

Correspondingly, if the BS schedules more than four TBs (or determines that the HARQ-ACK feedback exceeds 4 bits), then the BS expects the UE to generate and report HARQ-ACK feedback according to the first HARQ-ACK reporting mode.

In one implementation, a BS may use one DCI to schedules two TBs. The total number of the scheduled TBs by two pieces of DCI is four in this case. The last DCI should be the second DCI under HARQ-ACK feedback under the second reporting mode. In one implementation, the PRI in the second DCI may be set to have an indication that the second DCI is the last DCI.

In some implementation, a HARQ-ACK feedback may be associated with one or more G-RNTIs. The PRI field in the DCI may indicate the last DCI per G-RNTI. The UE may generate HARQ-ACK information per G-RNTI based on the last DCI. The UE may concatenate the generated HARQ-ACK value for the HARQ-ACK feedback under the second mode based on the G-RNTI value in an ascending or a descending.

For example, there may be two MBS services corresponding to two G-RNTIs in one MBS group. If the TBs corresponding to G-RNTI1 and G-RNTI2 are respectively scheduled for a same HARQ-ACK feedback under the second mode, the indication of the last DCI in G-RNTI1 and G-RNTI2 can be made separately in the respective DCI. The UE can generate the values of HARQ-ACK feedback for both G-RNTIs separately. Then, the UE can concatenate the HARQ-ACK values corresponding to G-RNTI1 and G-RNTI2 in ascending or descending order based on the G-RNTI values in order to obtain the HARQ-ACK feedback.

Alternatively, the DCI may indicate the last DCI across a plurality of G-RNTIs. In this case, the UE may generate HARQ-ACK information for the HARQ-ACK feedback under the second reporting mode based on the last DCI and the counting order across multiple G-RNTIs. For example, there may be two MBS services corresponding to two G-RNTIs in one MBS group. If the TBs corresponding to G-RNTI1 and G-RNTI2 are scheduled for a second HARQ-ACK report, then a last DCI can be indicated in the PRI field from the DCIs corresponding to the TBs associated with G-RNTI1 and G-RNTI2. The UE can generate the HARQ-ACK feedback for the TBs (including the TB corresponding to the last DCI). In this way, the HARQ-ACK feedback is obtained for G-RNTI1 and G-RNTI2.

This disclosure, as shown in FIG. 4, further provides a wireless communication method, including:
S210: receiving, from a base station, a signaling, wherein the signaling is used to configure a user equipment (UE) to transmit a HARQ-ACK feedback according to a preset rule in a case that a size of the HARQ-ACK feedback is equal to or less than 4 bits and/or when the UE is configured with one or more G-RNTIs (Group Radio Network Temporary Identities);
S220: generating the HARQ-ACK feedback by adding at least one NACK bit at the end of the HARQ-ACK feedback in response to an original size of the HARQ-ACK feedback is determined less than four bits based on a Counter-Downlink Assignment Index (C-DAI) in downlink control information; and
S230: transmitting the HARQ-ACK feedback to the BS.

In S210, the UE receives the signaling from the BS to perform the HARQ-ACK feedback under the second mode explained above. The UE may perform HARQ-ACK feedback when a size of the HARQ-ACK feedback is equal to or less than 4 bits and/or the UE is configured with one or more G-RNTIs.

In S220, the UE may generate the HARQ-ACK feedback. Based on the DCI actually received by the UE, the UE can determine an original size of the HARQ-ACK feedback. For example, if the DCI received by the UE indicates the UE to have 2 bits in the HARQ-ACK feedback (for example, because there are two corresponding scheduled TBs), the UE may determine that the original size of the HARQ-ACK feedback is 2 bits. However, the UE may supplement one or more NACK bit from the end of the HARQ-ACK feedback in addition to the original size. For example, the BS may use the signaling (such as RRC or MAC signaling) to indicate that HARQ-ACK feedback should have 4 bits (or other number of less than 4 bits). Alternatively, there may be a default setting to require the HARQ-ACK feedback to have a default size, which can be 4 bits, as an example. In this case, the BS may expect the UE will provide the HARQ-ACK feedback meeting the required size.

In another case, the UE may add at least one NACK bit at the end of the HARQ-ACK feedback to reach the required size of the HARQ-ACK feedback if there is no sufficient bits in the original size. As an example, the original size of the HARQ-ACK feedback may be less than the configured size (or the default size) of the HARQ-ACK feedback because the UE may has failed to receive certain DCI, so the UE's determination of the original size of the HARQ-ACK feedback is not relied on correct information.

In another example, in step S210, the BS may further configure the size of the HARQ-ACK feedback by signaling to be 4 bits. The BS may send 3 DCIs having C-DAI to schedule 3 TBs respectively. Assuming that the UE receives all TBs, the original size of the HARQ-ACK feedback determined by the UE based on C-DAI is 3 bits. However, since a size of 3 bits does not meet the configured size of the HARQ-ACK feedback, the UE may supplement one additional NACK at the end of the original HARQ-ACK feedback to meet the configured size of the HARQ-ACK feedback.

In another example, at Step S210, the BS may further configure the size of the HARQ-ACK feedback by signaling to be 4 bits. The BS may send 3 DCIs having C-DAI to schedule 3 TBs respectively. Assuming that the UE receives the first TB and the third TB and misses the second TB, the original size of the HARQ-ACK feedback determined by the UE based on C-DAI is still 3 bits because the end DCI (corresponding to the third TB) is correctly received. Additionally, based on the C-DAI in the end DCI, the UE can know that the second TB is missing. However, since a size of 3 bits does not meet the configured size of the HARQ-ACK feedback, the UE may supplement one additional NACK at the end of the original HARQ-ACK feedback to meet the configured size of the HARQ-ACK feedback.

In another example, at Step S210, the BS may further configure the size of the HARQ-ACK feedback by signaling to be 4 bits. The BS may send 3 DCIs including C-DAI to schedule 3 TBs respectively. Assuming that the UE receives the first TB and the second TB, and misses the third TB and the third DCI scheduling the third TB, the original size of the HARQ-ACK feedback determined by the UE based on C-DAI is 2 bits because from the UE's point of view, the end DCI (corresponding to the on the second TB) is correctly received. The UE is unaware that the actual end DCI (corresponding to the third TB) is missing. In this case, according to this method, since a size of 2 bits is less than the configured size of the HARQ-ACK feedback, the UE may supplement two additional NACKs at the end of the original HARQ-ACK feedback to reach the configured HARQ-ACK feedback size.

In another example, if it is determined that the original size of the HARQ-ACK feedback is greater than the configured size of the HARQ-ACK feedback, the BS and the UE may agree to stop performing the HARQ-ACK feedback. A scheduling restriction is defined for the BS, which restriction can prevent the BS from scheduling TBs exceeding the configured size for a HARQ-ACK feedback.

In still another example, if it is determined that the original size of the HARQ-ACK feedback is greater than the configured size of the HARQ-ACK feedback, the BS and the UE may agree to perform the HARQ-ACK reporting under the first HARQ-ACK reporting mode based on the determined HARQ-ACK information, even if the UE is configured to perform the second HARQ-ACK reporting mode.

In S230, the UE transmits the HARQ-ACK feedback to the BS. In one case, the size of the HARQ-ACK feedback is four bits (for example, with supplemented NACK bits) and a number of corresponding previously-transmitted TBs is less than four. For example, the UE may have added one or more NACK bits, while the BS actually only scheduled less than four TBs. In this case, the BS can determine whether a NACK bit has a corresponding previously scheduled TB before retransmitting the missing TB.

In this case, the BS expects the UE to transmit a HARQ-ACK feedback with the configured size or a predetermined (default) size. The BS also expects UE to supplement one or more NACK bits if the original size of the HARQ-ACK feedback the UE prepared based on the received TB(s) or DCI(s) is smaller than the configured size or a predetermined (default) size.

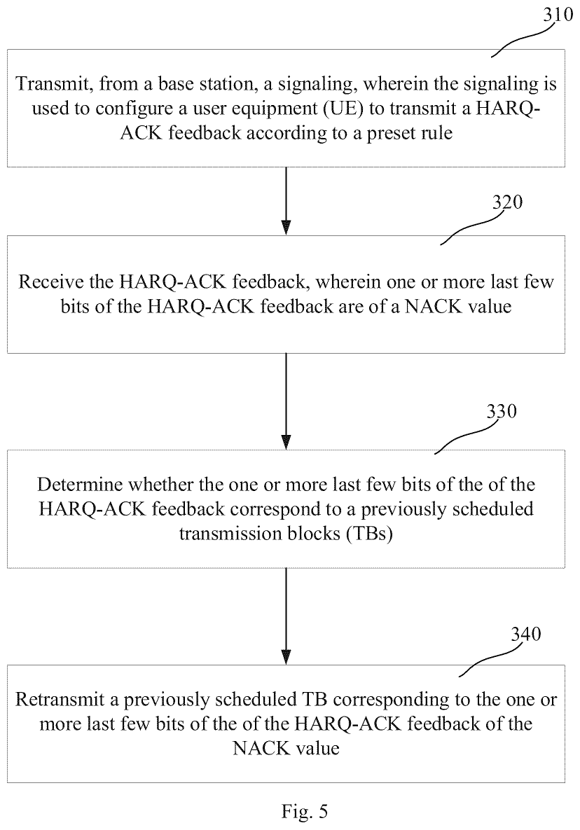

Correspondingly, this disclosure, as shown in FIG. 5, provides a wireless communication method, includes:
S310: transmitting, from a base station, a signaling, wherein the signaling is used to configure a user equipment (UE) to transmit a HARQ-ACK feedback according to a preset rule in a case that a size of the HARQ-ACK feedback is equal to or less than 4 bits and/or when the UE is configured with one or more G-RNTIs (Group Radio Network Temporary Identity);
S320: receiving the HARQ-ACK feedback, wherein one or more last few bits of the HARQ-ACK feedback are of a NACK value;
S330: determining whether the one or more last few bits of the of the HARQ-ACK feedback correspond to a previously scheduled transmission blocks (TBs); and
S340: retransmitting a previously scheduled TB corresponding to the one or more last few bits of the of the HARQ-ACK feedback of the NACK value.

In S310, the BS transmits a signaling, such as an RRC signaling, to the UE to ask UE to perform the HARQ-ACK feedback under the second reporting mode if the certain condition is met. Additionally, the BS may optionally use the same signaling or use another signaling to configure the size of the HARQ-ACK feedback. Alternatively, there may be a predetermined default size of the HARQ-ACK feedback. The predetermined size can be 4 bits in order to fully use the allocated PUCCH resource of in Table 1.

In S320, the BS may receive a HARQ-ACK feedback with one or more last few bits of the HARQ-ACK feedback are of a NACK value. For example, the BS may receive a HARQ-ACK feedback with a value of {1, 1, 0, 0}. The NACK value may indicate that a certain scheduled TB is not properly received/decoded, or the NACK value can be supplemented because the original size of the HARQ-ACK feedback does not reach the required size of the HARQ-ACK feedback.

In S330, because the UE may have supplemented one or more NACK bits in the HARQ-ACK feedback even if the UE does not receive a DCI confirming a certain TB is scheduled corresponding to the supplemented bit, the BS may determine whether a bit of the HARQ-ACK feedback having a NACK value corresponds to a previously-scheduled TB once it receives the HARQ-ACK feedback from the UE. For example, if the BS receives a HARQ-ACK feedback with {1, 1, 0, 0}, it is possible that the first NACK (the third bit from the left) corresponds to a previously scheduled TB, while the last NACK bit does not correspond to any previously scheduled TB, or vice versa. The NACK does not correspond to a previously scheduled TB because the UE supplement such bit while it does not receive DCI schedule the corresponding TB.

Once the TB receives a HARQ-ACK feedback with a NACK value, it may check whether each NACK value corresponding to one previously scheduled TB. If not, the BS may just disregard the NACK value without retransmitting the TBs. On the other hand, if the BS determines that the NACK indicates a missing TB (not properly received or decoded by the UE), the BS may retransmit the TB.

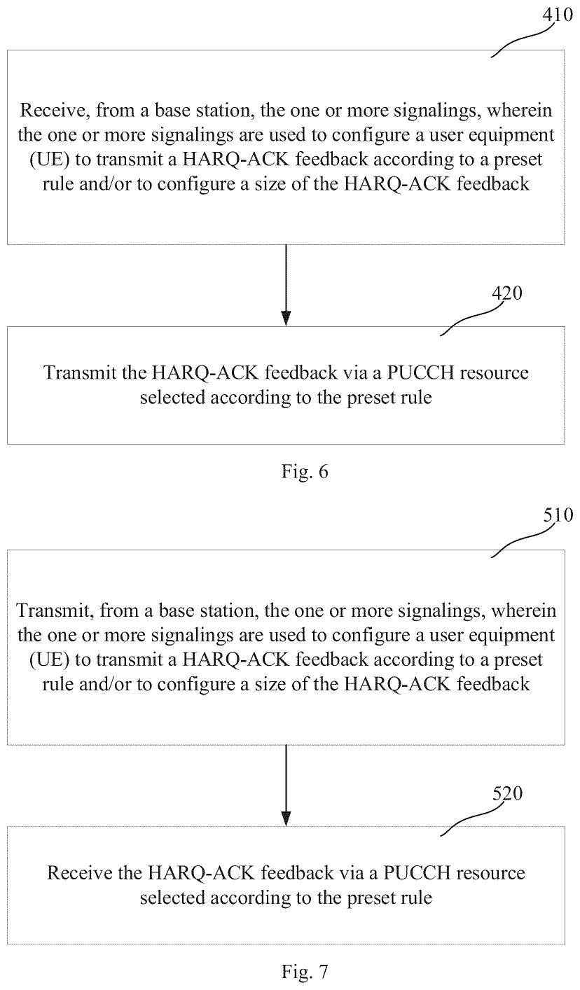

This disclosure, as shown in FIG. 6, further provides a wireless communication method, including:
S410: receiving, from a base station, the one or more signalings, wherein the one or more signalings are used to configure a user equipment (UE) to transmit a HARQ-ACK feedback according to a preset rule and/or to configure a size of the HARQ-ACK feedback in a case that the size of the HARQ-ACK feedback is equal to or less than 4 bits and/or when the UE is configured with one or more G-RNTIs (Group Radio Network Temporary Identities); and
S420: transmitting the HARQ-ACK feedback via a PUCCH resource selected according to the preset rule.

Correspondingly, this disclosure, as shown in FIG. 7, provides a wireless communication method, including:
S510: transmitting, from a base station, one or more signalings, wherein the one or more signalings are used to configure a user equipment (UE) to transmit a HARQ-ACK feedback according to a preset rule and/or to configure a size of the HARQ-ACK feedback when the size of the HARQ-ACK feedback is equal to or less than 4 bits and/or when the UE is configured with one or more G-RNTIs (Group Radio Network Temporary Identities); and
S520: receiving the HARQ-ACK feedback via a PUCCH resource selected according to the preset rule.

In S410, the UE may receive one or more signalings from BS. The one or more signalings may either configure the UE to report HARQ-ACK feedback under the second reporting mode or to configure a size of the HARQ-ACK feedback, or both. The operation may be conditioned on the size of the HARQ-ACK feedback is equal to or less than 4 bits and/or when the UE is configured with one or more G-RNTIs. Correspondingly, in S510, the BS transmits the one or more signalings. The configuration of the operation and the size of the HARQ-ACK feedback can be done in one signaling together, or can be done separately in more than one signaling.

In S420, the UE reports the HARQ-ACK feedback accordingly. In S520, the BS receives the HARQ-ACK feedback via a PUCCH resource selected according to the Table 1.

According to one implementation, one or more signalings are RRC signalings.

According to one implementation, this method further includes determining a bit of the HARQ-ACK feedback is NACK when corresponding downlink control information (DCI) or TB is not received. Specifically, when a UE fails to properly receive DCI or a TB (including fails to correctly decode a received TB), the UE may determine a bit of the HARQ-ACK feedback corresponding to the TB as NACK. For example, a NACK value can be represented as a value “0.” The UE may determine which bit should be NACK for the failure according to the sequence of the TB. For example, if the TB the UE failed to receive is the first scheduled TB in a HARQ-ACK feedback, the UE determines the first bit of the HARQ-ACK feedback (which corresponds to the missing TB) is NACK.

According to one implementation, this method further includes receiving one or more pieces of corresponding DCI indicating a sequence or a number of one or more transmission blocks (TBs). To inform of the UE of the sequence or order of the TBs scheduled by the BS, the BS may further transmit and the UE may receive one or more pieces of corresponding DCI. The DCIs can be used to indicate the sequence or a total number of the TBs scheduled by the TB.

According to one implementation, the one or more pieces of corresponding DCI includes a Counter-Downlink Assignment Index (C-DAI) for indicating a sequence or a number of the TBs; or a PUCCH resource indication (PRI) for indicating a sequence or a number of the TBs. In one implementation, the field used by the DCI to indicate the sequence or the number of the TBs can be a Counter-Downlink Assignment Index or a PUCCH resource indication field.

According to one implementation, the size of the HARQ-ACK feedback is N bit(s), N being a positive integer less than 5; and Kth to Nth bit(s) of the HARQ-ACK feedback are determined to have a NACK value, wherein the (K−1)th TB is the last TB received by the UE, K being a positive integer less than or equal to N. For example, the size of the HARQ-ACK feedback can be 3 bits. This size as mentioned above, can be determined by the BS using a signaling or can be preset as a default rule when there is no received signaling to configure the size of the HARQ-ACK feedback. When the first TB is the last TB received by the UE, the UE may determine that bits 2 to 3 (that is K is 2) is NACK.

In one example, the UE can supplement that last few bit(s) as NACK even if the UE does not receive the DCI that schedules the last few TB(s). For example, in a case that the UE does not receive DCI that schedules the last few TB(s), theoretically the UE may not know that there are some TB(s) is scheduled by the BS and are supposed to be received by the UE. In a conventional design, if the UE does not know that there are additional TB(s) supposed to be receive. Because the UE receives the TB the UE determined supposed to receive according to the received, the UE will not report a HARQ-ACK feedback under the second reporting mode. However, in this implementation here, the UE may still supplement a NACK value if the number of TBs it received corresponds to a smaller size of the HARQ-ACK feedback. The UE may supplement one or more NACK bits to the HARQ-ACK feedback until it reaches the predetermined size, and report the HARQ-ACK feedback with one or more NACK bits.

According to one implementation, one or more 1st to (K−1)th bits of the HARQ-ACK feedback are determined to have a NACK value in a case that the UE receives the Kth TBs but fails to receive one or more TBs corresponding to the one or more 1st to (K−1)th bits of the HARQ-ACK feedback determined to have the NACK value. Additionally, if the UE receives a TB, which according to the DCI is a TB scheduled following one or more preceding TBs, but the UE does not receive the one or more preceding TBs, the UE may determine that the one or more bits corresponding to the one or more non-received preceding TBs as NACK. For example, if the UE receives a TB, indicated by the DCI as the third TB, but the UE has not received the first and the second TBs, the UE may determine the bits of the HARQ-ACK feedback corresponding to the non-received first and second TBs as NACK. In this case, if the configured size of the HARQ-ACK feedback is 3 bits, the UE may report a HARQ-ACK feedback as {0, 0, 1}. According to Table 1, the UE may use the fifth PUCCH resource for the reporting.

According to one implementation, the method further comprises in a case that the size of the HARQ-ACK feedback is determined, based on the one or more pieces of DCI, smaller than the configured size of the HARQ-ACK feedback, adding one or more NACK bits at the end of the HARQ-ACK feedback to prepare the HARQ-ACK feedback having the configured size. For example, the UE may determine a size of the HARQ-ACK feedback based on the DCI. If the UE determined that according to the DCI the size of the HARQ-ACK feedback is less than a configured or predetermined size of the HARQ-ACK feedback, the UE may supplement the NACK bit at the end of the HARQ-ACK feedback. For example, if the one or more pieces of DCI received by the UE indicated that the last TB should be the third TB, the UE based on the received DCI may determine the HARQ-ACK feedback is of three bits. However, if the configured or predetermined size of the HARQ-ACK feedback (for example, as configured by the BS via an RRC signaling or by a default setting) is four bits, larger than the size indicated by the DCI, the UE may supplement the NACK bit at the last few bits of the HARQ-ACK feedback (in this case the last bit) such that the actual HARQ-ACK feedback transmitted by the UE meets the required size of the HARQ-ACK feedback as configured or predetermined.

According to one implementation, the size of the HARQ-ACK feedback is larger than a number of TBs the BS scheduled to be transmitted or the configured size of the HARQ-ACK feedback is larger than the size of the HARQ-ACK feedback determined based on the one or more pieces of DCIs. Because the UE may supplement one or more bits to the HARQ-ACK feedback (with a NACK value as an example), the configured size of the HARQ-ACK feedback (that can be the size of the HARQ-ACK feedback actually transmitted as the UE needs to comply with the configuration) can be larger than the HARQ-ACK feedback the UE can tell from the DCI scheduling the transmission of the TBs.

According to one implementation, in a case that the one or more signalings do not configured the size of the HARQ-ACK feedback, the UE transmit the HARQ-ACK feedback with a preset size. For example, in a case that the UE does not receive or the BS does not transmit a signaling to configure the size of the HARQ-ACK feedback, the UE can alternatively use a default setting of the size of the HARQ-ACK feedback.

According to one implementation, the method further includes determining whether a bit of the HARQ-ACK feedback having a NACK value corresponds to a previously-scheduled TB.

According to one implementation, the method further includes, in a case that the bit of the HARQ-ACK feedback having a NACK value corresponds to a previously-scheduled TB, retransmitting the corresponding previously-scheduled TB.

According to one implementation, the method further comprises, in a case that the bit of the HARQ-ACK feedback having a NACK value, is devoid of a corresponding previously-scheduled TB, disregarding the bit of the HARQ-ACK feedback having a NACK value.

Specifically, because the UE may supplement one or more NACK bits in the HARQ-ACK feedback even if the UE does not receive a DCI confirming a certain TB is scheduled corresponding to the supplemented bit, the BS may need to determine whether a bit of the HARQ-ACK feedback having a NACK value actually corresponds to a previously-scheduled TB after the BS receives the HARQ-ACK feedback from the UE. For example, if the BS receives a HARQ-ACK feedback with {1, 1, 0, 0}, it is possible that the first NACK (the third bit from the left) corresponds to a previously scheduled TB (which was not received by the UE), while the last NACK bit (the fourth bit overall) does not correspond to any previously scheduled TB, or vise versa. The NACK does not correspond to a previously scheduled TB because the UE supplement such bit while it does not receive DCI schedule the corresponding TB.

Once the TB receives a HARQ-ACK feedback with a NACK value, it may check whether each NACK value corresponding to one previously scheduled TB. If not, the BS may disregard the NACK value without retransmitting the TBs. On the other hand, if the BS determines that the NACK indicates a missing TB (not properly received or decoded by the UE), the BS may retransmit the TB.

The following provides additional methods for supporting the second HARQ-ACK report, which may be used to solve the issue of missing TBs at the end of the second HARQ-ACK report.

In some embodiments, the network may configure a plurality of multicast or broadcast services (MBS) for a plurality of UEs. An MBS service may be a broadcast service that may be received by all the UEs in a serving cell or a multicast service that may be received by a part of or all the UEs in the serving cell. Different UEs may receive the different MBS services. A NACK-only feedback may be configured for a UE for an MBS. In this case, if the UE does not successfully decode the PDSCH with the TBs, it may transmit PUCCH with the NACK-only feedback. If the UE successfully decodes the PDSCH, it may not transmit PUCCH with the NACK-only feedback. Alternatively, if the UE does not successfully decode at least one of a plurality of PDSCHs, it may transmit PUCCH the NACK-only feedback. If the UE successfully decodes all of the plurality of PDSCHs, it may not transmit PUCCH.

An MBS service (or the PDCCH or PDSCH of the MBS) may be scrambled by a G-RNTI or G-CS-RNTI. Therefore, the MBS may be represented by the G-RNTI or G-CS-RNTI. For example, the PDSCH or PDCCH of MBS A is scrambled by G-RNTI 1. Then MBS A can be represented by G-RNTI 1.

### First Extra Exemplary Solution

The network may transmit a plurality of PDSCHs to the UE. The network may indicate that the respective PUCCH resources for NACK-only feedback for the plurality of PDSCHs are in the same slot or sub-slot. The UE may determine the final PUCCH resource for the NACK-only feedback for the plurality of PDSCHs according to the decoding results of one or more of the plurality of PDSCHs. In some embodiments, if the UE can determine the DCI missing (or PDSCH missing) for at least one of the plurality of PDSCHs, the missed DCI (or missed PDSCH) may also be considered for the PUCCH resource determination. If the missed PDSCH (or missed PDCCH) is for the MBS that is received by the UE, NACK (or HARQ value ‘0’) may be assumed for the missed PDSCH (or missed PDCCH) when considered for the PUCCH resource determination. If the missed PDSCH (or missed PDCCH) is for the MBS that is not received by the UE, ACK (or HARQ value ‘1’) may be assumed for the missed PDSCH (or missed PDCCH) when considered for the PUCCH resource determination.

A scheduling scheme for the plurality of PDSCHs may be indicated by the DCI. It may be indicated by a field in the DCI or by more than one fields in the DCI together. The respective PUCCH resources for the plurality of PDSCHs may be in the same slot or sub-slot based on the indication. The scheduling scheme may at least include the MBS for one or more of the plurality of PDSCHs. For example, the plurality of PDSCHs may include 4 PDSCHs. The scheduling scheme for the 4 PDSCHs includes the MBS service for the first PDSCH, the MBS service for the second PDSCH, the MBS service for the third PDSCH, and the MBS service for the fourth PDSCH.

The plurality of PDSCHs may be sorted by the corresponding G-RNTI or G-CS-RNTI, e.g., in the ascending order of the G-RNTI or G-CS-RNTI value. The PDSCHs for the same MBS service may be sorted by the transmission slot of the DCI or PDSCH, the frequency resource of the DCI or PDSCH, the transmission carrier of the DCI or PDSCH, or the combination of them. For example, the PDSCHs for the same MBS may be sorted in the ascend order of the PDCCH transmission occasion (slot).

The network may configure a plurality of scheduling schemes for the UE. The plurality of scheduling schemes may have respective scheduling scheme indices. The scheduling scheme index may be indicated by the DCI.

The UE may determine the PUCCH resource according to at least the indicated scheduling scheme. For the PDSCH corresponding to the MBS service that is not received by the UE, ACK is assumed for PUCCH resource determination.

Table 1A illustrates an example of the transmission scheme configuration. The network configures 4 MBS services, denoted by MBS A, MBS B, MBS C, and MBS D, respectively. The scheduling schemes and the corresponding scheduling scheme indices configured by the network are shown in the Table 1A.

TABLE 1A

| Index | Scheduling scheme |
|---|---|
| 0 | A/B/C/D |
| 1 | AB |
| 2 | AD |
| 3 | BC |
| 4 | AAD |
| 5 | BCC |
| 6 | BCD |
| 7 | CCD |
| 8 | ABBC |
| 9 | ABCD |
| 10 | ACDD |
| 11 | BBCC |
| 12 | BCCD |
| 13 | BCDD |
| 14 | CCCC |
| 15 | CCDD |

The index 0 (scheduling scheme 0) indicates that there is only one PDSCH that may carry MBS A, MBS B, MBS C, or MBS D. The index 1 (scheduling scheme 1) indicates that there are two PDSCHs with the corresponding PUCCH resources in the same slot or sub-slot. The first PDSCH carries the MBS A and the second PDSCH carries the MBS B. Similarly, the index 2 (scheduling scheme 2) indicates that there are two PDSCHs with the corresponding PUCCH resource in the same slot or sub-slot. The first PDSCH carries the MBS A and the second PDSCH carries the MBS D. The index 4 (scheduling scheme 4) indicates that there are three PDSCHs with the corresponding PUCCH resources in the same slot or sub-slot. The first two PDSCHs carry the MBS A and the third PDSCH carries the MBS D.

The index 8 (scheduling scheme 8) indicates that there are four PDSCHs with the corresponding PUCCH resources in the same slot or sub-slot. The first PDSCH carries the MBS A. The second and the third PDSCH carry the MBS B. The fourth PDSCH carries the MBS C. Similarly, the configurations of the other scheduling schemes are shown in Table 1A.

The index may be indicated by a field in the DCI. For example, there is a 4-bit field in the DCI for indicating the index or the scheduling scheme. The 4-bit field value of ‘0000’ indicates the index 0 (or the scheduling scheme A/B/C/D). The 4-bit field value of ‘0001’ indicates the index 1 (or the scheduling scheme AB), and so on.

The index may be indicated by more than fields together. For example, the PUCCH resource indicator (PRI) field in the DCI has three bits. There is a 1-bit field in the DCI for indicating the index or the scheduling scheme in conjunction with the PRI field. The 1-bit field value ‘0’ and the PRI field value ‘000’ indicate the index 0 (or the scheduling scheme A/B/C/D) together. The 1-bit field value ‘0’ and the PRI field value ‘001’ indicate the index 1 (or the scheduling scheme AB) together, and so on. The 1-bit field value ‘1’ and the PRI field value ‘000’ indicate the index 8 (or the scheduling scheme ABBC) together. The 1-bit field value ‘1’ and the PRI field value ‘001’ indicate the index 9 (or the scheduling scheme ABCD) together, and so on.

Assume UE 1 only receives the MBS A, UE 2 only receives MBS B, UE 3 only receives MBS B and MBS D and UE 4 only receives MBS A and MBS C. There are 15 PUCCH resources in the resource list.

In one case, the network transmits PDSCH 1 carrying MBS A and PDSCH 2 carrying MBS B. PDSCH 1 is scheduled by DCI 1, and PDSCH 2 is scheduled by DCI 2. Therefore, scheduling scheme index 1 is indicated by DCI 1 or DCI 2. UE 1 or UE 4 may only receive the DCI 1 and PDSCH 1. UE 2 or UE 4 may only receive the DCI 2 and PDSCH 2.

For UE 1 or UE 4, ACK (i.e., 1) is assumed for the second PDSCH (i.e., PDSCH 2) since the second PDSCH is for the MBS B, which is not received by the UE 1 or UE 4. The second bit in the HARQ value is always 1. Therefore, the HARQ value ‘01’ may be used for UE 1 or UE 4 to determine the PUCCH resource depending on the PDSCH 1 decoding result. More specifically, ‘01’ is used, and therefore the third PUCCH resource is determined (or selected) when UE 1 or UE 4 does not successfully decode the PDSCH 1.

For UE 2 or UE 3, ACK (i.e., 1) is assumed for the first PDSCH (i.e., PDSCH 1) since the first PDSCH is for the MBS A, which is not received by the UE 2 or UE 3. The first bit in the HARQ value is always 1. Therefore, the HARQ value ‘10’ may be used for UE 2 or UE 3 to determine the PUCCH resource depending on the PDSCH 2 decoding result. More specifically, ‘10’ is used, and therefore the second PUCCH resource is determined (or selected) when UE 2 or UE 3 does not successfully decode the PDSCH 2.

In another case, the network transmits PDSCH 3, PDSCH 4, PDSCH 5 and PDSCH 6 carrying MBS A, MBS B, MBS C and MBS D, respectively. These PDSCHs are scheduled by DCI 3, DCI 4, DCI 5 and DCI 6, respectively. Therefore, the scheduling index 9 is indicated. UE 1 may only receive DCI 3 and PDSCH 3. UE 2 may only receive DCI 4 and PDSCH 4. UE 3 may only receive DCI 4, DCI 6, PDSCH 4 and PDSCH 6. UE 4 may only receive DCI 3, DCI 5, PDSCH 3 and PDSCH 5.

For UE 1, ACK (i.e., 1) is assumed for the second PDSCH (i.e., PDSCH 4), the third PDSCH (i.e., PDSCH 5) and the fourth PDSCH (i.e., PDSCH 6) since these PDSCHs are for the MBS other than MBS A, which are not received by the UE 1. The second bit, third bit and the fourth bit in the HARQ value are always 1. Therefore, the HARQ value ‘0111’ may be used for UE 1 to determine the PUCCH resource depending on the PDSCH 1 decoding result. More specifically, ‘0111’ is used, and therefore the fifteenth PUCCH resource is determined (or selected) when UE 1 does not successfully decode the PDSCH 1.

For UE 2, ACK (i.e., 1) is assumed for the first PDSCH (i.e., PDSCH 3), the third PDSCH (i.e., PDSCH 5) and the fourth PDSCH (i.e., PDSCH 6) since these PDSCHs are for the MBS other than MBS B, which are not received by the UE 2. The first bit, third bit and the fourth bit in the HARQ value are always 1. Therefore, the HARQ value ‘1011’ may be used for UE 2 to determine the PUCCH resource depending on the PDSCH 4 decoding result. More specifically, ‘1011’ is used, and therefore the fourteenth PUCCH resource is determined (or selected) when UE 2 does not successfully decode the PDSCH 4.

For UE 3, ACK (i.e., 1) is assumed for the first PDSCH (i.e., PDSCH 3) and the third PDSCH (i.e., PDSCH 5) since these PDSCHs are for the MBS A and MBS C, which are not received by the UE 3. The first bit and the third bit in the HARQ value are always 1. Therefore, the HARQ value ‘1010’, ‘1110’, or ‘1011’ may be used for UE 3 to determine the PUCCH resource depending on the PDSCH 4 and PDSCH 6 decoding results. More specifically, ‘1010’ is used, and therefore the sixth PUCCH resource is determined (or selected) when UE 3 does not successfully decode the PDSCH 4 or PDSCH 6. ‘1110’ is used, and therefore the eighth PUCCH resource is determined (or selected) when UE 3 successfully decodes the PDSCH 4 and does not decode PDSCH 6 successfully. ‘1011’ is used, and therefore the fourteenth PUCCH resource is determined (or selected) when UE 3 successfully decode the PDSCH 6 and does not decode PDSCH 4 successfully.

For UE 4, ACK (i.e., 1) is assumed for the second PDSCH (i.e., PDSCH 4) and the fourth PDSCH (i.e., PDSCH 6) since these PDSCHs are for the MBS B and MBS D, which are not received by the UE 4. The second bit and the fourth bit in the HARQ value are always 1. Therefore, the HARQ value ‘0101’, ‘1101’, or ‘0111’ may be used for UE 4 to determine the PUCCH resource depending on the PDSCH 3 and PDSCH 5 decoding results. More specifically, ‘0101’ is used, and therefore the eleventh PUCCH resource is determined (or selected) when UE 4 does not successfully decode the PDSCH 3 or PDSCH 5. ‘1101’ is used, and therefore the twelfth PUCCH resource is determined (or selected) when UE 4 successfully decodes the PDSCH 3 and does not decode PDSCH 5 successfully. ‘0111’ is used, and therefore the fifteenth PUCCH resource is determined (or selected) when UE 4 successfully decode the PDSCH 5 and does not decode PDSCH 3 successfully.

For a UE, the network may configure a plurality of PUCCH resource sets. A PUCCH resource set may include a plurality of PUCCH resources. A PUCCH resource may be included in more than one PUCCH resource sets. It implies that at least two PUCCH resource sets may share a same PUCCH resource. There may be a PUCCH resource set index configured for a PUCCH resource set.

### Second Extra Exemplary Solution

The network may configure a plurality of transmission schemes for the UE. In addition, the network may configure the relationship between a transmission scheme and a PUCCH resource set. More specially, a transmission scheme may correspond to (or be associated with) a PUCCH resource set. It is understood that more than one transmission schemes may correspond to one PUCCH resource set.

The transmission scheme is indicated by the DCI in accordance with above embodiment. The UE may use the PUCCH resource set associated with the transmission scheme indicated by the DCI for HARQ feedback (or NACK-only feedback). Within the PUCCH resource set, the UE may select (or determine) the PUCCH resource according to the PDSCH decoding results. Only the PDSCH for the MBS that is received by the UE may be used for determining the PUCCH resource. The PDSCH for the MBS that is not received by the UE may not be considered for determining the PUCCH resource.

Table 2, Table 3 and Table 4 illustrate some examples of the PUCCH resource set configuration. The network transmits two MBS services, denoted by MBS A and MBS B, respectively. There are three UEs, denoted by UE 1, UE 2, and UE 3, respectively. UE 1 only receives MBS A. UE 2 only receives MBS B. UE 3 receives both MBS A and MBS B. There are totally 15 PUCCH resources, denoted by PUCCH resource 0-14, respectively.

TABLE 2

| | | PUCCH | | | PUCCH |
|---|---|---|---|---|---|
| | Scheduling | resource | | Scheduling | resource |
| Index | scheme | set | Index | scheme | set |
| 0 | A | 1_0 | 7 | ABB | 1_0 |
| 1 | B | N/A | 8 | BBB | N/A |
| 2 | AA | 1_1 | 9 | AAAA | 1_3 |
| 3 | AB | 1_0 | 10 | AAAB | 1_2 |
| 4 | BB | N/A | 11 | AABB | 1_1 |
| 5 | AAA | 1_2 | 12 | ABBB | 1_0 |
| 6 | AAB | 1_1 | 13 | BBBB | N/A |

| | |
|---|---|
| PUCCH resource set 1_0 | PUCCH resource 14 |
| PUCCH resource set 1_1 | PUCCH resource 12, 13, 14 |
| PUCCH resource set 1_2 | PUCCH resource 8, 9, 10, 11, 12, 13, 14 |
| PUCCH resource set 1_3 | PUCCH resource 0, 1, 2, 3, 4, 5, 6, 7, |
| | 8, 9, 10, 11, 12, 13, 14 |

Table 2 illustrates an example of the transmission scheme and corresponding PUCCH resource set for UE 1. As illustrated, the network configures 4 PUCCH resource sets for UE 1, i.e., PUCCH resource set 1_0, PUCCH resource set 1_1, PUCCH resource set 1_2, and PUCCH resource set 1_3. PUCCH resource set 1_0 includes only PUCCH resource 14. PUCCH resource set 1_1 includes PUCCH resource 12, 13 and 14. PUCCH set 1_2 includes PUCCH resource 8, 9, 10, 11, 12, 13 and 14. PUCCH resource set 1_3 includes all the 15 PUCCH resources, i.e., PUCCH resource 0-14. For UE 1, the network configures that scheduling scheme 0, 3, 7, and 12 correspond to PUCCH resource set 1_0. The scheduling scheme 2, 6 and 11 correspond to PUCCH set 1_1. Scheduling scheme 5 and 10 correspond to PUCCH set 1_2. Scheduling scheme 9 corresponds to PUCCH resource set 1_3.

Assume UE 1 receives PDSCH 1. PDSCH 1 is scheduled by DCI 1. DCI 1 indicates the scheduling scheme 3. Therefore, UE 1 selects PUCCH resource set 1_0. Then PUCCH resource 14 is selected since there is only one PUCCH resource in PUCH resource set 1_0. If UE 1 successfully decodes the PDSCH 1, it does not transmit PUCCH. If UE 1 does not decode PDSCH 1 successfully, it transmits PUCCH by using PUCCH resource 14.

Assume the network transmits PDSCH 2 and PDSCH 3 to UE 1. Also, the network transmits the other PDSCHs to the other UEs. PDSCH 2 and PDSCH 3 are scheduled by DCI 2 and DCI 3, respectively. DCI 2 or DCI 3 indicates the scheduling scheme 11. UE 1 receives DCI 2 or DCI 3. UE 1 selects PUCCH resource set 1_1. Within PUCCH resource set 1_1, the PUCCH resource is determined based on the decoding results of at least one of the PDSCH 2 and PDSCH 3. According to the scheduling scheme 11, UE 1 can determine that there are two PDSCHs for MBS A. UE 1 can further determines that PDSCH 2 is the first PDSCH for MBS A and PDSCH 3 is the second PDSCH for MBS A according to the downlink assignment index (DAI) in the DCI 2 or DCI 3.

In one case, UE 1 receives both DCI 2 and DCI 3. If UE 1 does not decode PDSCH 2 or PDSCH 3 successfully, the HARQ value ‘00’ is determined and therefore the first PUCCH resource in the PUCCH resource set 1_1 (i.e., PUCCH resource 12) is selected for PUCCH transmission. If UE 1 does not decode PDSCH 2 successfully but decodes PDSCH 3 successfully, the HARQ value ‘01’ is determined and therefore the third PUCCH resource in the PUCCH resource set 1_1 (i.e., PUCCH resource 14) is selected for PUCCH transmission. If UE 1 does not decode PDSCH 3 successfully but decodes PDSCH 2 successfully, the HARQ value ‘10’ is determined and therefore the second PUCCH resource in the PUCCH resource set 1_1 (i.e., PUCCH resource 13) is selected for PUCCH transmission.

In another case, UE 1 only receives DCI 2. UE 1 can determine that the second DCI and PDSCH are missing since the scheduling scheme 11 indicated by DCI 2 implies that there are two PDSCHs for MBS A. Therefore, NACK (or HARQ value ‘0’) is assumed for the second PDSCH (i.e., PDSCH 3). The second bit of the HARQ value is always 0 for PUCCH resource determination. If UE 1 does not decode PDSCH 2 successfully, the HARQ value ‘00’ is determined and therefore the first PUCCH resource in the PUCCH resource set 1_1 (i.e., PUCCH resource 12) is selected for PUCCH transmission. If UE 1 decodes PDSCH 2 successfully, the HARQ value ‘10’ is determined and therefore the second PUCCH resource in the PUCCH resource set 1_1 (i.e., PUCCH resource 13) is selected for PUCCH transmission.

In another case, UE 1 only receives DCI 3. UE 1 can determine that the first DCI and PDSCH are missing since the scheduling scheme 11 indicated by DCI 3 implies that there are two PDSCHs for MBS A. Therefore, NACK (or HARQ value ‘0’) is assumed for the first PDSCH (i.e., PDSCH 2). The first bit of the HARQ value is always 0 for PUCCH resource determination. If UE 1 does not decode PDSCH 3 successfully, the HARQ value ‘00’ is determined and therefore the first PUCCH resource in the PUCCH resource set 1_1 (i.e., PUCCH resource 12) is selected for PUCCH transmission. If UE 1 decodes PDSCH 3 successfully, the HARQ value ‘01’ is determined and therefore the third PUCCH resource in the PUCCH resource set 1_1 (i.e., PUCCH resource 14) is selected for PUCCH transmission. In any case, UE 1 transmits PUCCH on the selected PUCCH resource.

Table 3 illustrates an example of the transmission scheme and corresponding PUCCH resource set for UE 2. As illustrated, the network configures 4 PUCCH resource sets for UE 2, denoted by PUCCH resource set 2_0, PUCCH resource set 2_1, PUCCH resource set 2 2 and PUCCH resource set 2_3, respectively. PUCCH resource set 2_0 includes PUCCH resource 1, 3, 5, 7, 9, 11, and 13. PUCCH resource set 2_1 includes PUCCH resource 3, 7, and 11. PUCCH resource set 2_2 includes only PUCCH resource 7. PUCCH resource set 2_3 includes all the 15 PUCCH resources, i.e., PUCCH resource 0-14. For UE 2, the network configures that transmission scheme 3, 7 and 12 correspond to PUCCH resource set 2_0. Transmission scheme 6 and 11 correspond to PUCCH resource set 2_1. Transmission scheme 10 corresponds to PUCCH resource set 2_2. Transmission scheme 1, 4, 8 and 13 correspond to PUCCH resource set 2 3.

TABLE 3

| | | PUCCH | | | PUCCH |
|---|---|---|---|---|---|
| | Scheduling | resource | | Scheduling | resource |
| Index | scheme | set | Index | scheme | set |
| 0 | A | N/A | 7 | ABB | 2_0 |
| 1 | B | 2_3 | 8 | BBB | 2_3 |
| 2 | AA | N/A | 9 | AAAA | N/A |
| 3 | AB | 2_0 | 10 | AAAB | 2_2 |
| 4 | BB | 2_3 | 11 | AABB | 2_1 |
| 5 | AAA | N/A | 12 | ABBB | 2_0 |
| 6 | AAB | 2_1 | 13 | BBBB | 2_3 |

| | |
|---|---|
| PUCCH resource set 2_0 | PUCCH resource 1, 3, 5, 7, 9, 11, 13 |
| PUCCH resource set 2_1 | PUCCH resource 3, 7, 11 |
| PUCCH resource set 2_2 | PUCCH resource 7 |
| PUCCH resource set 2_3 | PUCCH resource 0, 1, 2, 3, 4, 5, 6, 7, |
| | 8, 9, 10, 11, 12, 13, 14 |

Assume UE 2 only receives PDSCH 4. PDSCH 4 is scheduled by DCI 4. DCI 4 indicates the scheduling scheme 6. Therefore, UE 2 selects PUCCH resource set 2_1. Within PUCCH resource set 2_1, which PUCCH resource is selected for transmission depends on the PDSCH 4 decoding results. If UE 4 does not decode the PDSCH 4 successfully, the HARQ value ‘0’ is determined and therefore the first PUCCH resource in the PUCCH resource set 2_1 (i.e., PUCCH resource 3) is selected for PUCCH transmission.

Assume the network transmits PDSCH 5 and PDSCH 6 to UE 2. Also, the network transmits the other PDSCHs to the other UEs. PDSCH 5 and PDSCH 6 are scheduled by DCI 5 and DCI 6, respectively. DCI 5 or DCI 6 indicates the scheduling scheme 7. UE 2 receives DCI 5 or DCI 6. UE 2 selects PUCCH resource set 2_0. Within PUCCH resource set 2_0, which PUCCH resource is determined for transmission depends on the decoding results of at least one of the PDSCH 5 and PDSCH 6. According to the scheduling scheme 7, UE 2 can determine that there are two PDSCHs for MBS B. UE 2 can further determines that PDSCH 5 is the first PDSCH for MBS B and PDSCH 6 is the second PDSCH for MBS B according to the downlink assignment index (DAI) in the DCI 5 or DCI 6.

In one case, UE 2 receives both DCI 5 and DCI 6. If UE 2 does not decode PDSCH 5 or PDSCH 6 successfully, the HARQ value ‘00’ is determined and therefore the first PUCCH resource in the PUCCH resource set 2_0 (i.e., PUCCH resource 1) is selected for PUCCH transmission. If UE 2 does not decode PDSCH 5 successfully but decodes PDSCH 6 successfully, the HARQ value ‘01’ is determined and therefore the third PUCCH resource in the PUCCH resource set 2_0 (i.e., PUCCH resource 5) is selected for PUCCH transmission. If UE 2 does not decode PDSCH 6 successfully but decodes PDSCH 5 successfully, the HARQ value ‘10’ is determined and therefore the second PUCCH resource in the PUCCH resource set 2_0 (i.e., PUCCH resource 3) is selected for PUCCH transmission.

In another case, UE 2 only receives DCI 5. UE 2 can determine that the second DCI and PDSCH are missing since the scheduling scheme 7 indicated by DCI 5 implies that there are two PDSCHs for MBS B. Therefore, NACK (or HARQ value ‘0’) is assumed for the second PDSCH (i.e., PDSCH 6). The second bit of HARQ value is always 0 for PUCCH resource determination. If UE 2 does not decode PDSCH 5 successfully, the HARQ value ‘00’ is determined and therefore the first PUCCH resource in the PUCCH resource set 2_0 (i.e., PUCCH resource 1) is selected for PUCCH transmission. If UE 2 decodes PDSCH 5 successfully, the HARQ value ‘10’ is determined and therefore the second PUCCH resource in the PUCCH resource set 2 0 (i.e., PUCCH resource 3) is selected for PUCCH transmission.

In another case, UE 2 only receives DCI 6. UE 2 can determine that the first DCI and PDSCH are missing since the scheduling scheme 7 indicated by DCI 6 implies that there are two PDSCHs for MBS B. Therefore, NACK (or HARQ value ‘0’) is assumed for the first PDSCH (i.e., PDSCH 5). The first bit of HARQ value is always 0 for PUCCH resource determination. If UE 2 does not decode PDSCH 6 successfully, the HARQ value ‘00’ is determined and therefore the first PUCCH resource in the PUCCH resource set 2_0 (i.e., PUCCH resource 1) is selected for PUCCH transmission. If UE 2 decodes PDSCH 6 successfully, the HARQ value ‘01’ is determined and therefore the third PUCCH resource in the PUCCH resource set 2_0 (i.e., PUCCH resource 5) is selected for PUCCH transmission. In any case, UE 2 transmits PUCCH on the selected PUCCH resource.

Table 4 illustrates an example of the transmission scheme and corresponding PUCCH resource set for UE 3. The network configures only one PUCCH resource set for UE 3, denoted by PUCCH resource set 3_0. PUCCH resource set 3_0 includes all the 15 PUCCH resources, i.e., PUCCH resource 0-14. All the transmission schemes correspond to the PUCCH resource set 3_0.

TABLE 4

| | | PUCCH | | | PUCCH |
|---|---|---|---|---|---|
| | Scheduling | resource | | Scheduling | resource |
| Index | scheme | set | Index | scheme | set |
| 0 | A | 3_0 | 7 | ABB | 3_0 |
| 1 | B | 3_0 | 8 | BBB | 3_0 |
| 2 | AA | 3_0 | 9 | AAAA | 3_0 |
| 3 | AB | 3_0 | 10 | AAAB | 3_0 |
| 4 | BB | 3_0 | 11 | AABB | 3_0 |
| 5 | AAA | 3_0 | 12 | ABBB | 3_0 |
| 6 | AAB | 3_0 | 13 | BBBB | 3_0 |

| | |
|---|---|
| PUCCH resource set 3_0 | PUCCH resource 0, 1, 2, 3, 4, 5, 6, |
| | 7, 8, 9, 10, 11, 12, 13, 14 |

Assume the network transmits PDSCH 7 and PDSCH 8 to UE 3. PDSCH 7 and PDSCH 8 are scheduled by DCI 7 and DCI 8, respectively. DCI 7 or DCI 8 indicates the scheduling scheme 3. UE 3 receives DCI 7 or DCI 8. UE 3 selects PUCCH resource set 3_0 according to the indicated scheduling scheme. Within PUCCH resource set 3_0, which PUCCH resource is determined for transmission depends on the decoding results of at least one of the PDSCH 7 and PDSCH 8. According to the scheduling scheme 3, UE 3 can determine that there are two PDSCHs. One is for MBS A and one is for MBS B. UE 3 can further determines that PDSCH 7 is the first PDSCH for and PDSCH 8 is the second PDSCH.

In one case, UE 3 receives both DCI 7 and DCI 8. If UE 3 does not decode PDSCH 7 or PDSCH 8 successfully, the HARQ value ‘00’ is determined and therefore the first PUCCH resource in the PUCCH resource set 3_0 (i.e., PUCCH resource 0) is selected for PUCCH transmission. If UE 3 does not decode PDSCH 7 successfully but decodes PDSCH 8 successfully, the HARQ value ‘01’ is determined and therefore the third PUCCH resource in the PUCCH resource set 3_0 (i.e., PUCCH resource 2) is selected for PUCCH transmission. If UE 3 does not decode PDSCH 8 successfully but decodes PDSCH 7 successfully, the HARQ value ‘10’ is determined and therefore the second PUCCH resource in the PUCCH resource set 3_0 (i.e., PUCCH resource 1) is selected for PUCCH transmission.

In another case, UE 3 only receives DCI 7. UE 3 can determine that the second DCI and PDSCH are missing since the scheduling scheme 3 indicated by DCI 7 implies that there are two PDSCHs. Therefore, NACK (or HARQ value ‘0’) is assumed for the second PDSCH (i.e., PDSCH 8). The second bit of the HARQ value is always 0 for PUCCH resource determination. If UE 3 does not decode PDSCH 7 successfully, the HARQ value ‘00’ is determined and therefore the first PUCCH resource in the PUCCH resource set 3_0 (i.e., PUCCH resource 0) is selected for PUCCH transmission. If UE 3 decodes PDSCH 7 successfully, the HARQ value ‘10’ is determined and therefore the second PUCCH resource in the PUCCH resource set 3_0 (i.e., PUCCH resource 1) is selected for PUCCH transmission.

In another case, UE 3 only receives DCI 8. UE 3 can determine that the first DCI and PDSCH are missing since the scheduling scheme 3 indicated by DCI 8 implies that there are two PDSCHs. Therefore, NACK (or HARQ value ‘0’) is assumed for the first PDSCH (i.e., PDSCH 7). The first bit of the HARQ value is always 0 for PUCCH resource determination. If UE 3 does not decode PDSCH 8 successfully, the HARQ value ‘00’ is determined and therefore the first PUCCH resource in the PUCCH resource set 3_0 (i.e., PUCCH resource 0) is selected for PUCCH transmission. If UE 3 decodes PDSCH 8 successfully, the HARQ value ‘01’ is determined and therefore the third PUCCH resource in the PUCCH resource set 3_0 (i.e., PUCCH resource 2) is selected for PUCCH transmission. In any case, UE 3 transmits PUCCH on the selected PUCCH resource.

In accordance with the embodiments, different UEs can share the same PUCCH resource even though they may receive different MBS services. This can save the PUCCH resource overhead significantly.

The methods/steps disclosed above can be performed by the UE, the BS, and the wireless communication device as disclosed in FIG. 1. Additionally, the hardware of the UE, the BS, and the wireless communication system may include non-transitory computer readable storage medium, storing one or more instructions. When the one or more instruction is executed by a processor, a wireless communication device is caused to perform the methods/steps as disclosed above.

Various exemplary embodiments of the present disclosure are described below with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

1. A wireless communication method, comprising:
receiving, from a base station, one or more signalings, wherein the one or more signalings are used to configure a user equipment (UE) to transmit a HARQ-ACK feedback according to a preset rule and/or to configure a size of the HARQ-ACK feedback in a case that the size of the HARQ-ACK feedback is equal to or less than 4 bits and/or when the UE is configured with one or more G-RNTIs (Group Radio Network Temporary Identities); and
transmitting the HARQ-ACK feedback via a PUCCH resource selected according to the preset rule.

2. (canceled)

3. (canceled)

4. The method of claim 1, further comprising receiving one or more pieces of corresponding DCI indicating a sequence or a number of one or more transmission blocks (TBs).

5. The method of claim 4, wherein the one or more pieces of corresponding DCI including:
a Counter-Downlink Assignment Index (C-DAI) for indicating the sequence or the number of the TBs; or
a PUCCH resource indication (PRI) for indicating the sequence or the number of the TBs.

6. The method of claim 1, wherein:
the size of the HARQ-ACK feedback is N bit(s), N being a positive integer less than 5; and
the method further comprises:
determining Kth to Nth bit(s) of the HARQ-ACK feedback to have a NACK value, wherein the (K−1)th TB is the last TB received by the UE, K being a positive integer less than or equal to N; and/or
determining one or more 1st to (K−1)th bits of the HARQ-ACK feedback to have a NACK value in a case that the UE receives the Kth TBs but fails to receive one or more TBs corresponding to the one or more 1st to (K−1)th bits of the HARQ-ACK feedback determined to have the NACK value.

7. The method of claim 1, further comprising in a case that the size of the HARQ-ACK feedback is determined, based on one or more pieces of DCI, smaller than the configured size of the HARQ-ACK feedback, adding one or more NACK bits at the end of the HARQ-ACK feedback to prepare the HARQ-ACK feedback having the configured size.

8. The method of claim 7, wherein the configured size of the HARQ-ACK feedback is larger than the size of the HARQ-ACK feedback determined based on the one or more pieces of DCIs.

9. The method of claim 1, wherein the preset rule defines a relationship between a value of the HARQ-ACK feedback and the selected PUCCH resource.

10. The method of claim 1, wherein in a case that the one or more signalings do not configure the size of the HARQ-ACK feedback, the UE transmit the HARQ-ACK feedback with a preset size.

11. A wireless communication method, comprising:
transmitting, from a base station, one or more signalings, wherein the one or more signalings are used to configure a user equipment (UE) to transmit a HARQ-ACK feedback according to a preset rule and/or to configure a size of the HARQ-ACK feedback when the size of the HARQ-ACK feedback is equal to or less than 4 bits and/or when the UE is configured with one or more G-RNTIs (Group Radio Network Temporary Identities); and
receiving the HARQ-ACK feedback via a PUCCH resource selected according to the preset rule.

12. (canceled)

13. (canceled)

14. The method of claim 11, further comprising transmitting one or pieces of more corresponding DCI indicating a sequence or a number of one or more transmission blocks (TBs).

15. The method of claim 14, wherein the one or more pieces of corresponding DCIs including a Counter-Downlink Assignment Index (C-DAI) for indicating the sequence or the number of the TBs; or
a PUCCH resource indication (PRI) for indicating the sequence or the number of the TBs.

16. The method of claim 11, wherein:
the size of the HARQ-ACK feedback is N bit(s), N being a positive integer less than 5; and
Kth to Nth bit(s) of the HARQ-ACK feedback are determined to have a NACK value, wherein the (K−1)th TB is the last TB received by the UE, K being a positive integer less than or equal to N; and/or
one or more 1st to (K−1)th bits of the HARQ-ACK feedback are determined to have a NACK value in a case that the UE receives the Kth TBs but fails to receive one or more TBs corresponding to the one or more 1st to (K−1)th bits of the HARQ-ACK feedback determined to have the NACK value.

17. The method of claim 11, wherein in a case that the size of the HARQ-ACK feedback is determined, based on one or more pieces of DCI, smaller than the configured size of the HARQ-ACK feedback, one or more NACK bits are added at the end of the HARQ-ACK feedback to prepare the HARQ-ACK feedback having the configured size.

18. The method of claim 11, wherein the configured size of the HARQ-ACK feedback is larger than the size of the HARQ-ACK feedback determined based on the one or more pieces of DCIs.

19. The method of claim 11, further comprising determining whether a bit of the HARQ-ACK feedback having a NACK value corresponds to a previously-scheduled TB.

20. The method of claim 19, further comprising, in a case that the bit of the HARQ-ACK feedback having a NACK value corresponds to a previously-scheduled TB, retransmitting the corresponding previously-scheduled TB.

21. The method of claim 19, further comprising, in a case that the bit of the HARQ-ACK feedback having a NACK value is devoid of a corresponding previously-scheduled TB, disregarding the bit of the HARQ-ACK feedback having a NACK value.

22-58. (canceled)

59. A wireless communication apparatus, comprising a memory storing one or more programs and a processor electrically coupled to the memory and configured to execute the one or more programs to perform the method according to claim 1.

60. A non-transitory computer-readable storage medium, storing one or more programs, the one or more program being configured to, when executed by a processor, cause to perform the method according to claim 1.
